(19) United States
(12) Patent Application Publication
(10) Pub. No.: US 2004/0155027 A1
(43) Pub. Date: Aug. 12, 2004

(54) Oven controller structure

(76) Inventor: Sandy Huang, Tainan (TW)

Correspondence Address: BIRCH STEWART KOLASCH & BIRCH, PO BOX 747, FALLS CHURCH, VA, 22040-0747, US

(21) Appl. No.: 10/359,186

(22) Filed: Feb. 6, 2003

(51) Int. Cl. H05B 1/02

(52) U.S. Cl. 219/489; 219/482

(57) ABSTRACT

The present invention discloses to an improved oven controller structure, which adds an external insulating cover to a controller disposed at the periphery of an oven according to the position of placing the oven, and the controller could be changed to one with cable transmission, wireless sensing, or embedded controller according to the predetermined configuration. The controller is detachable from the oven, and the oven can be controlled rapidly by a controller at the outside of the housing and the information about the operation of each component of inside the oven is known.

### FIELD OF INVENTION

The present invention relates to an improved oven controller structure, more particularly a controller that can be detached from the oven and insulated from the heat source.

### BACKGROUND OF THE INVENTION

At present, there are various ovens used by consumers. Although there are control buttons on the panel of the oven, the panel having the control buttons does not have the structure for insulating the heat source, which does not have the safety feature in its application of the conduction. Therefore, the control buttons on the panel of the oven only has a single function, and the user is unable to have the information whether or not the components such as the heating tube and power supply in the interior of the oven. Such oven cannot maximize its functions to adapt different situations of applications, and thus limiting the cope of its application.

Hence, the present invention focuses on the prior art for the research and development of a controller, which can be detached from the periphery of the oven and has an external cover. The controller can be designed as one with cable transmission, wireless access sensing or an embedded controller according to the variation and different position of placing the oven, so that the controller is detachable from the oven.

### SUMMARY OF THE INVENTION

The controller of the oven according to the present invention is disposed at the periphery of the oven, and the controller can be designed as one with cable transmission, wireless access sensing or an embedded controller according to the variation and position of placing the oven, so that the controller is detached from the oven and insulated from the heat source. The housing of the oven can be controlled rapidly outside the housing of the casing and the information about the normal sensitivity of each component in the oven is obtained, so that the controller can be used to control the function of the oven according to different requirements of the application.

In view of the analysis described above, the present invention obviously has the following features and functions:

Firstly, the controller of the present invention is disposed at the periphery of the oven, and the controller can be one with cable transmission, wireless access sensing, or an embedded controller, so that the controller can fit the function of the oven to be used in different situations.

Secondly, the cable or wireless controller of the present invention disposed at the periphery of the oven, and the controller is installed in the external cover to facilitate the direct access by hands. A protective circuit can be added into the controller to disconnect the power when the temperature of the controller exceeds 60° C.

Thirdly, the cable or wireless controller of the present invention can use the control switch to perform different functions, and also synchronously control the ON/OFF of the internal components of the oven, so that the controller can be separated from the oven and has an insulation from the heat source.

### BRIEF DESCRIPTION OF THE DRAWINGS

FIG. 1 is a perspective diagram of the controller of the oven of the present invention.

FIG. 2 is a perspective diagram of the controller shown in FIG. 1 being hung on the lateral side of the oven.

FIG. 3 is a perspective diagram of an oven of a first preferred embodiment of the present invention.

FIG. 4 is a perspective diagram of an oven of a second preferred embodiment of the present invention.

FIG. 5 is the front-view diagram of an oven as depicted in FIG. 4.

FIG. 6 is a perspective diagram of an oven of a third preferred embodiment of the present invention.

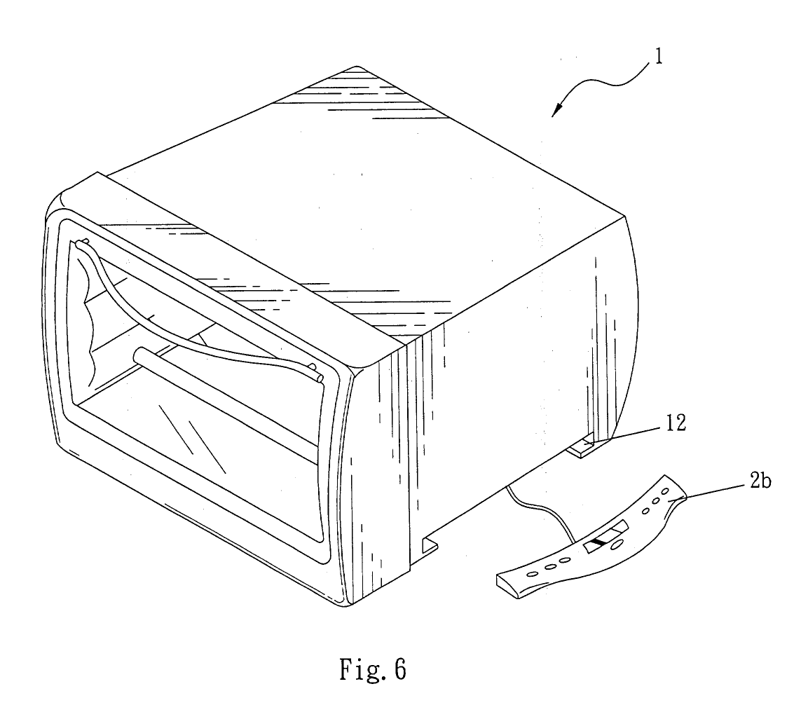

FIG. 7 is a perspective diagram of an oven of a fourth preferred embodiment of the present invention.

FIG. 8 is a perspective diagram of an oven of a fifth preferred embodiment of the present invention.

### DETAILED DESCRIPTION OF THE PREFERRED EMBODIMENTS

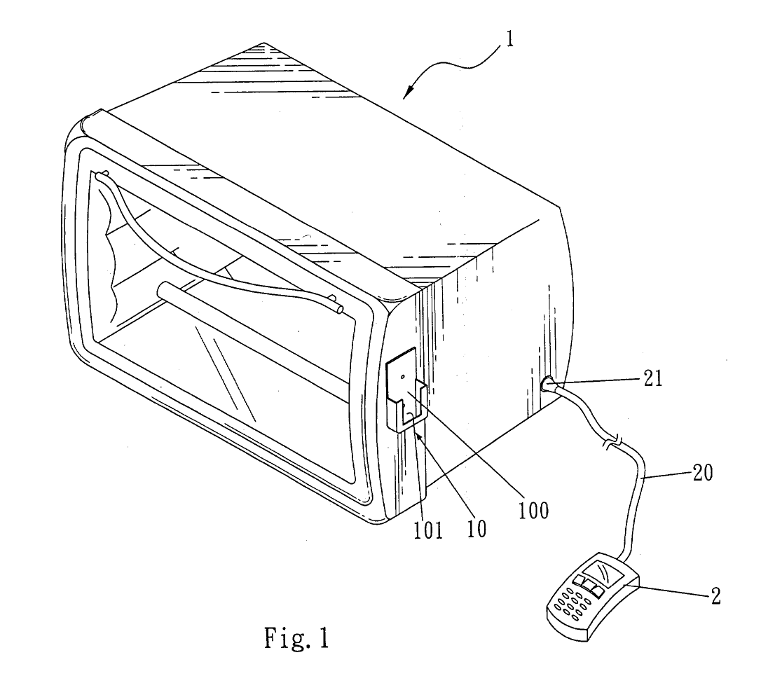

Please refer to FIG. 1 for a perspective diagram of the oven of the present invention. In the figure, the present invention comprises an oven 1 and a controller 2; wherein:

said oven 1 at its periphery (said oven is disposed on the lateral side of the oven in this embodiment) is coupled to a controller 2, and the a cover 10 is installed to the periphery of the oven 1, and said cover 10 has a fixed member 100 and an accommodating space inside the fixed member 100;

said controller 2 at one end has a power cable 20, and said power cable 20 has a protective cover 21 installed at the position where one end of the power cable 20 is coupled with the housing of the oven 1, such that the housing of the oven 1 has a controller 2 detachable from the housing of the oven 1 and has the insulation from the heat source. The controller 2 can control the switch to operate different functions, and control the internal temperature of the oven 1 by turning on and off the components, so that the protective circuit in the controller 2 can prevent the controller from exceeding the temperature of 60° C. when being placed inside the oven and the baking temperature keeps on rising, and prevent the controller from being electrically disconnected.

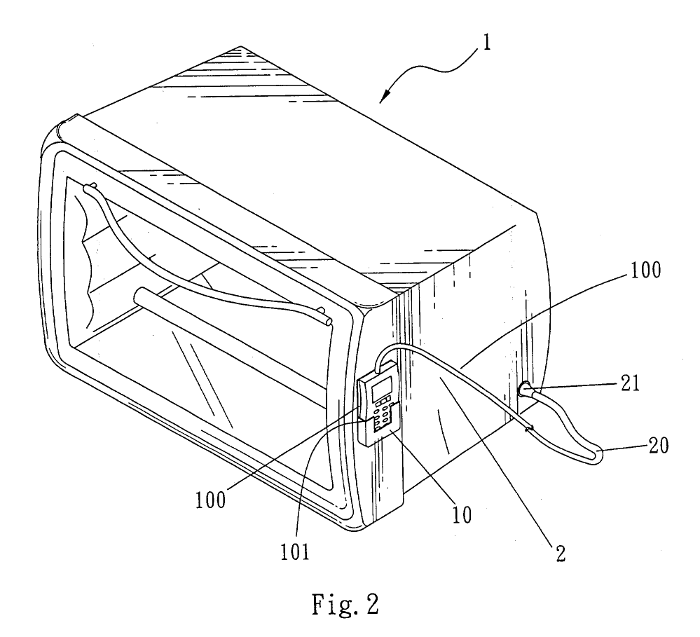

When the oven is in use, the controller 2 disposed on the lateral side of the oven and having an external cover 10 with an accommodating space 101 inside can be directly accessed by hands in a rapid and convenient manner. After all kinds of control buttons such as the timer/temperature, electrothermal tube, and power supply are set on the controller, the controller is placed into the accommodating space 101 of the cover 10 as depicted in FIG. 2 for rapidly controlling and obtaining the information of the normality of the sensitivity of each component inside the oven 1.

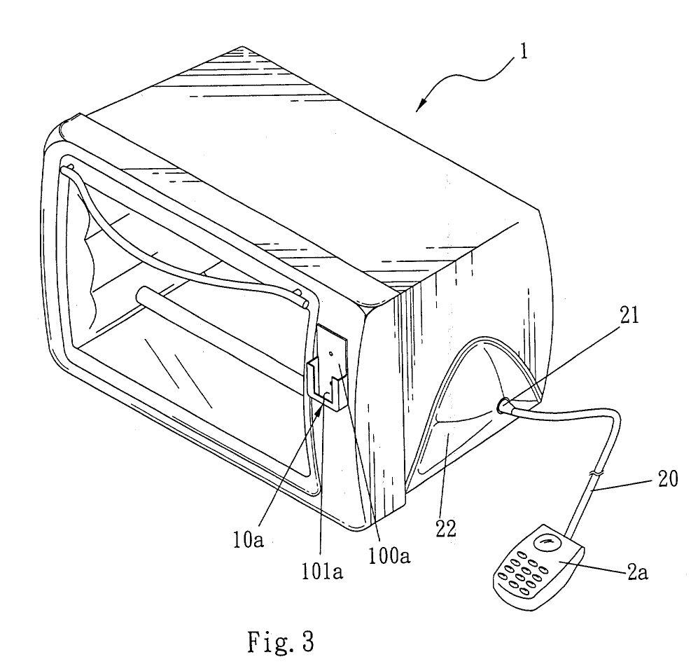

Please refer to FIG. 3 for an embodiment of installing the controller on the lateral side of the panel of the oven. The structure is substantially the same as the oven according to the embodiment as shown in FIG. 1. However, a cover 10a installed on the lateral side of the panel of the oven 1 comprises a fixed member 100a that can insulate the heat source, and an accommodating space 101a inside the cover 10a, and a power supply block 22 for accommodating ach power supply is protruded from the lateral bottom of the oven 1, and a cable controller 2a is extended from the power supply block 22.

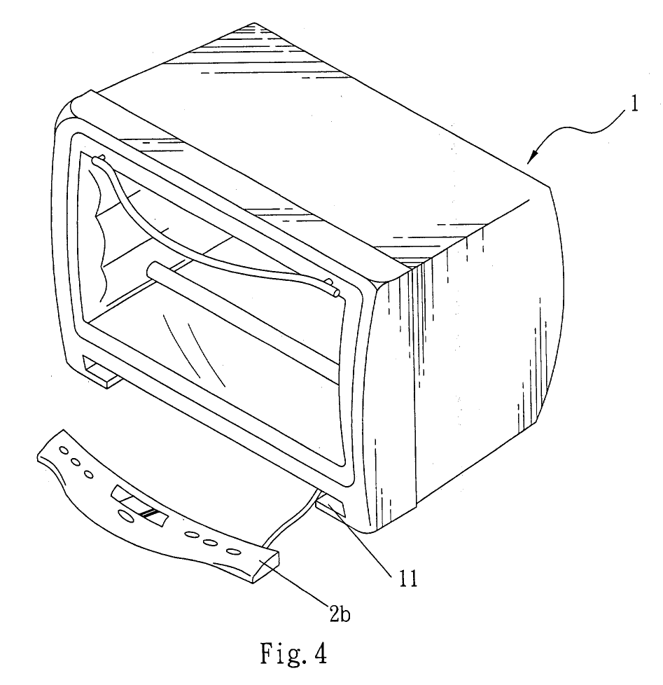

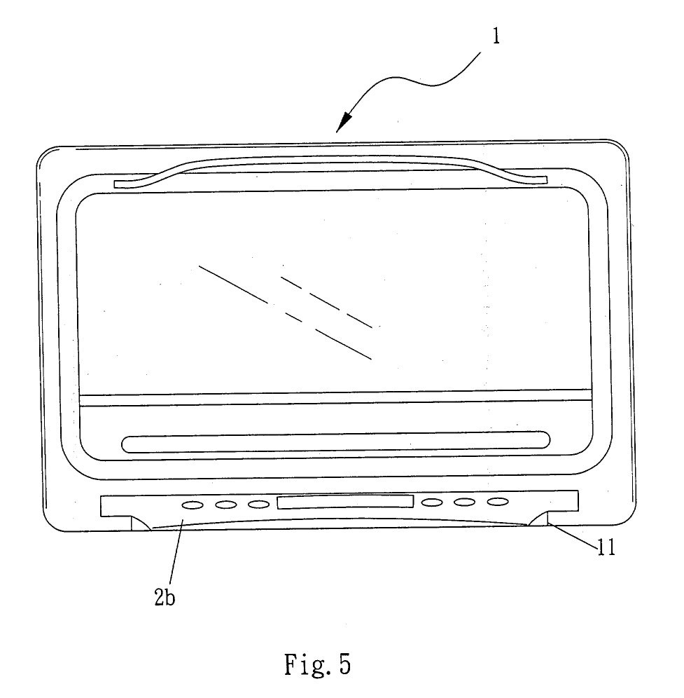

Please refer to FIGS. 4 and 5 for another embodiment of the oven substantially similar to that depicted in FIG. 1. However, the difference resides in that the front bottom of the oven 1 has a track 11 for receiving the embedded controller 2b, and the controller is a hidden one.

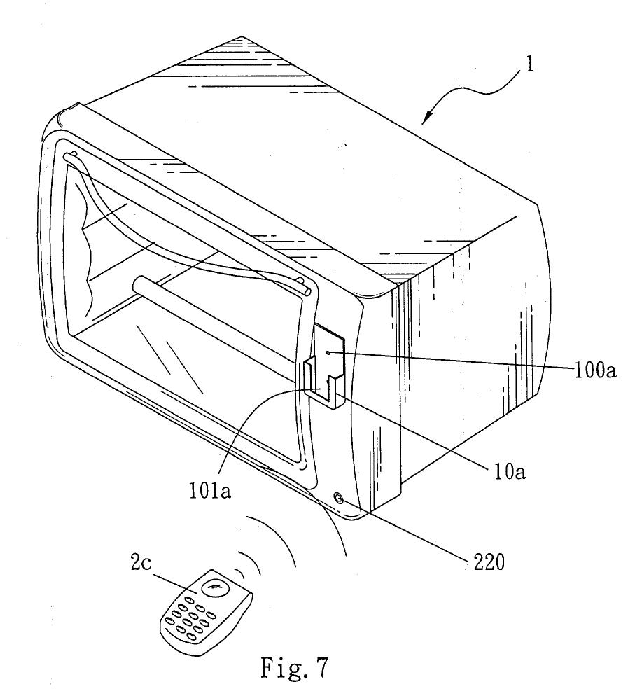

Further, refer to FIG. 7 for another embodiment of the oven substantially similar to that depicted in FIG. 3. However, the difference resides in that a cover 10a is installed onto the lateral side of the panel of the oven 1, and receiver 220 is disposed at an appropriate position on the lateral side of the oven such that a wireless controller 2C can be assessed to control the controller directly.

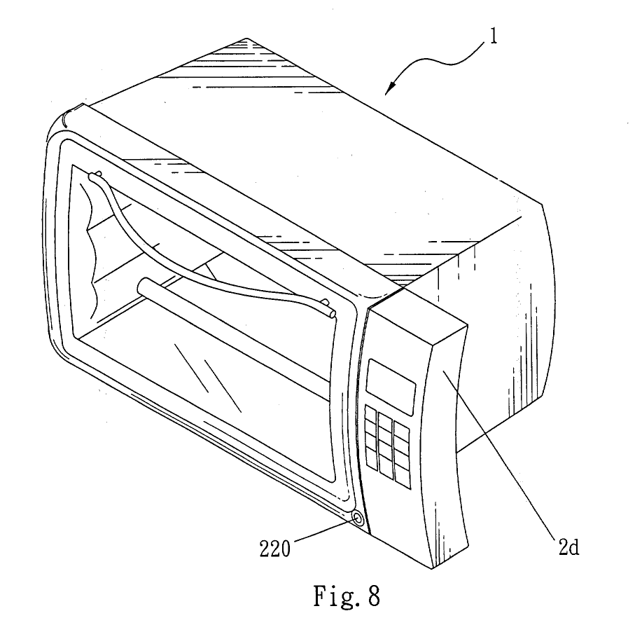

Please refer to FIG. 8 for another embodiment of the oven substantially similar to that depicted in FIG. 3. However, the difference resides in that a latch member (not shown in the figure) is disposed at the periphery of the oven 1 for latching a wireless controller 2d, and a receiver 220 is disposed at an appropriate position on the periphery of the oven such that the wireless controller 2d can be accessed to control the controller directly.

In summation of the above description, the present invention definitely can accomplish the expected objectives and functions, an enhance the performance of the conventional structure, and thus complies with the patent application requirements and is submitted to the Patent and Trademark Office for review and granting of the commensurate patent rights.

What is claimed is:

1. An improved oven controller structure, comprising:
an oven, at its periphery installing a cover, and said cover having a fixed member, and an accommodating space defined inside the cover;
a controller, being disposed in said accommodating space, having a power cable extended from one side of the controller, and one side of said power cable having a protective cover installed at the position where one end of said power cable being coupled to a housing of the oven, such that the controller outside the housing of the oven being used to control the switch and synchronously enabling and disabling the component inside the oven, and the controller being detached from the oven and insulated from a heat source.

2. The improved oven controller structure of claim 1, wherein said oven has a power supply block protruded from the periphery thereof, and a cable controller is extended from the power supply block.

3. The improved oven controller structure of claim 1, wherein said oven has a receiver disposed at the periphery thereof such that a wireless controller is accessed directly for controlling the oven.

4. The improved oven controller structure of claim 1, wherein said oven has a track at the periphery thereof, such that an embedded controller is inserted into said track.

5. The improved oven controller structure of claim 1, wherein said oven at its bottom has a track.

6. The improved oven controller structure of claim 1, wherein said oven has a latch member at the periphery thereof, such that a wireless controller is latched into said latch member.
